(19) United States
(12) Patent Application Publication
(10) Pub. No.: US 2011/0300823 A1
(43) Pub. Date: Dec. 8, 2011

(54) IMAGE REJECTION MIXER AND WIRELESS COMMUNICATION DEVICE

(75) Inventors: Kenji Kawakami, Tokyo (JP); Masaomi Tsuru, Tokyo (JP); Hiroyuki Mizutani, Tokyo (JP); Yusuke Kitsukawa, Tokyo (JP)

(73) Assignee: MITSUBISHI ELECTRIC CORPORATION, Chiyoda-ku, Tokyo (JP)

(21) Appl. No.: 12/673,323

(22) PCT Filed: Oct. 2, 2007
(86) PCT No.: PCT/JP2007/069246

§ 371 Date: Feb. 12, 2010

(51) Int. Cl. H04B 1/26

(52) U.S. Cl. 455/323

(57) ABSTRACT

An image rejection mixer and a communication device, which may suppress unwanted frequency components of a high power output assuming a fourth-order harmonic mixer. The image rejection mixer and communication device include first and second fourth-order harmonic mixers, a 90-degree IF synthesis distributor, a 90-degree LO distributor, and a 90-degree RF synthesis distributor. Use of the 90-degree distributors for LO distribution of the fourth-order harmonic image rejection mixer suppresses the unwanted frequency components of the high power output.

### TECHNICAL FIELD

The present invention relates to an image rejection mixer and a wireless communication device such as a communication device or a radar device that uses the image rejection mixer.

### BACKGROUND ART

As a conventional art, there is an image rejection mixer that performs distribution of a radio frequency (hereinafter, referred to as RF) signal with a 90 degrees hybrid circuit and performs in-phase distribution of a local oscillator (hereinafter, referred to as LO) power with a Wilkinson power distributor. In addition, there is a harmonic mixer for extracting intermediate frequency (hereinafter, referred to as IF) signal and RF signal components by using an antiparallel diode pair in which diodes are connected to each other at reversed polarity (see Non-Patent Document 1).

Non Patent Document 1: Masayoshi Aikawa, Takashi Ohira, Tsuneo Tokumitsu, Tetsuo Hirota, and Mashiro Muraguchi, “Monolithic microwave integrated circuit (MMIC)”, The Institute of Electronics, Information and Communication Engineers, Jan. 25, 1995 first edition, Page 118-119 and Page 120-122.

### DISCLOSURE OF THE INVENTION

### Problem to be Solved by the Invention

The conventional image rejection mixer is used for a main purpose of suppressing an image signal, but there is a problem that a lot of unwanted frequency components exist at the vicinity of a certain RF frequency as a desired wave in the case of a harmonic mixer.

The present invention is created in view of the above-mentioned problem, and it is an object of the present invention to provide an image rejection mixer and a communication device that may suppress unwanted frequency components of a high power output assuming a fourth-order harmonic mixer.

### Means for Solving the Problems

An image rejection mixer according to the present invention includes: first and second fourth-order harmonic mixers, each including an LO terminal, an IF terminal, and an RF terminal, and outputs, as a desired wave, an RF as a mixed wave of a fourth order component of an input LO signal frequency and a first order component of an IF, or the IF as a mixed wave of an even order component of the input LO signal frequency and a first order component of the RF; a 90-degree IF synthesis distributor which distributes and outputs an input signal at a first terminal from second and third terminals with a phase difference of 90 degrees, or synthesizes an input signal at a second terminal and an input signal at a third terminal after delaying a phase of the input signal at the second terminal by 90 degrees and outputs the synthesized signal from the first terminal; a 90-degree LO distributor which distributes and outputs an input signal at a first terminal from second and third terminals with a phase difference of 90 degrees; and a 90-degree RF synthesis distributor which distributes and outputs an input signal at a first terminal from second and third terminals with a phase difference of 90 degrees and outputs from a third terminal a signal having a phase delay of 90 degrees with respect to a phase output from the second terminal, or synthesizes an input signal at a second terminal with an input signal at a third terminal after leading a phase of the input signal at the second terminal by 90 degrees and outputs the synthesized signal from the first terminal, in which: the second terminal of the 90-degree IF synthesis distributor is connected to the IF terminal of the first fourth-order harmonic mixer; the third terminal of the 90-degree IF synthesis distributor is connected to the IF terminal of the second fourth-order harmonic mixer; the second terminal of the 90-degree LO distributor is connected to the LO terminal of the first fourth-order harmonic mixer; the third terminal of the 90-degree LO distributor is connected to the LO terminal of the second fourth-order harmonic mixer; the second terminal of the 90-degree RF synthesis distributor is connected to the RF terminal of the first fourth-order harmonic mixer; and the third terminal of the 90-degree RF synthesis distributor is connected to the RF terminal of the second fourth-order harmonic mixer.

Further, a wireless communication device according to the present invention is the image rejection mixer using the above-mentioned structure.

### Effects of the Invention

According to the present invention, a 90-degree LO distributor having a phase difference of 90 degrees is used instead of an LO distributor in a structure of the conventional image rejection mixer so that unwanted frequency components of a high power output may be suppressed.

### BRIEF DESCRIPTION OF THE DRAWINGS

FIG. 1 is a block diagram illustrating a structure of an image rejection mixer according to Embodiment 1 of the present invention.

FIG. 2 is an output spectrum diagram illustrating a conventional mixer for comparison with Embodiment 1 of the present invention.

FIG. 3 is an output spectrum diagram in an image rejection mixer of a conventional example having a structure using an even harmonic mixer with an APDP, for comparison with the image rejection mixer according to Embodiment 1 of the present invention.

FIG. 4 is an output spectrum diagram illustrating an effect of the image rejection mixer according to Embodiment 1 of the present invention.

FIG. 5 is a block diagram illustrating a structure of an image rejection mixer according to Embodiment 2 of the present invention.

FIG. 6 is a block diagram illustrating a structure of an image rejection mixer according to Embodiment 3 of the present invention.

FIG. 7 is a block diagram illustrating a structure of an image rejection mixer according to Embodiment 4 of the present invention.

FIG. 8 is a block diagram illustrating a structure of a communication device according to Embodiment 5 of the present invention.

### BEST MODE FOR CARRYING OUT THE INVENTION

### Embodiment 1

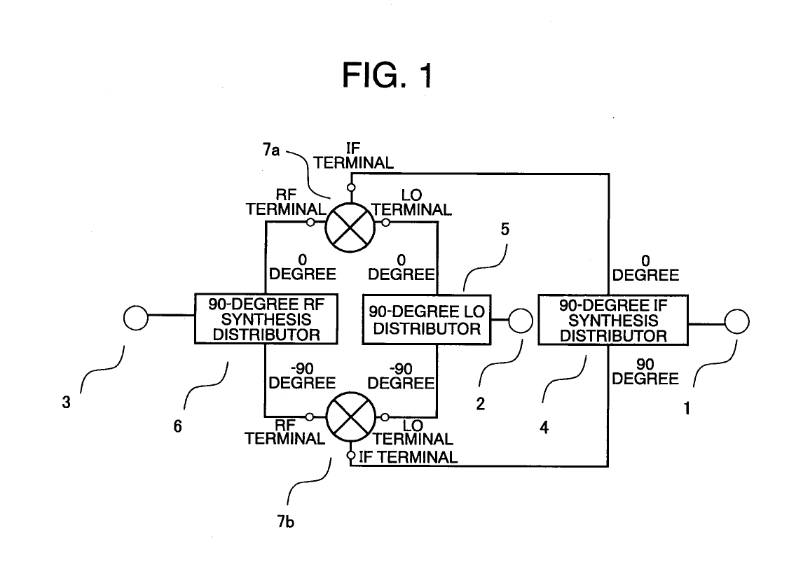

FIG. 1 is a block diagram illustrating a structure of an image rejection mixer according to Embodiment 1 of the present invention. The image rejection mixer illustrated in FIG. 1 includes first and second fourth-order harmonic mixers 7a and 7b that output an RF as a mixed wave of a fourth order component of an input LO signal frequency and an IF first order component, or an IF as a mixed wave of the even order component of the input LO signal frequency and an RF first order component as a desired wave, a 90-degree IF synthesis distributor 4 which distributes and outputs an input signal at a first terminal from second and third terminals with a phase difference of 90 degrees, or synthesizes an input signal at the second terminal and an input signal at the third terminal after delaying a phase of the signal at the second terminal by 90 degrees and outputs the synthesized signal from the first terminal, a 90-degree LO distributor 5 which distributes and outputs an input signal at a first terminal from second and third terminals with a phase difference of 90 degrees, and a 90-degree RF synthesis distributor 6 which distributes and outputs an input signal at a first terminal from second and third terminals with a phase difference of 90 degrees and outputs from the third terminal a signal having a phase delay of 90 degrees with respect to a phase output from the second terminal, or synthesizes an input signal at the second terminal with an input signal at the third terminal after leading a phase of the signal at the second terminal by 90 degrees and outputs the synthesized signal from the first terminal. In FIG. 1, reference numeral 1 denotes an IF signal input and output terminal, reference numeral 2 denotes an LO signal input terminal, and reference numeral 3 denotes an RE signal input and output terminal.

In this case, the second terminal of the 90-degree IF synthesis distributor 4 is connected to an IF terminal of the first fourth-order harmonic mixer 7a, the third terminal of the 90-degree IF synthesis distributor 4 is connected to an IF terminal of the second fourth-order harmonic mixer 7b, the second terminal of the 90-degree LO distributor 5 is connected to an LO terminal of the first fourth-order harmonic mixer 7a, the third terminal of the 90-degree LO distributor 5 is connected to an LO terminal of the second fourth-order harmonic mixer 7b, the second terminal of the 90-degree RF synthesis distributor 6 is connected to an RF terminal of the first fourth-order harmonic mixer 7a, and the third terminal of the 90-degree RF synthesis distributor 6 is connected to an RF terminal of the second fourth-order harmonic mixer 7b.

Next, an operation is described. The present invention uses, similarly to the conventional example, the first and the second fourth-order harmonic mixers 7a and 7b that input the IF signal and the LO signal and extract frequency components of ±IF+4×LO by using a nonlinear element such as an antiparallel diode pair (hereinafter, referred to as APDP) in which diodes are connected antiparallel to each other so that unwanted frequency components are suppressed by this connection method.

A transmission system is exemplified for description. Note that the 90-degree IF synthesis distributor 4 operates as a 90-degree IF distributor and the 90-degree RF synthesis distributor 6 operates as a 90-degree RF synthesizer in the transmission system. A signal input from the IF input and output terminal 1 is distributed by the 90-degree IF synthesis distributor 4 with a phase difference of 90 degrees and is input to the two mixers 7a and 7b. In this case, it is supposed that a phase of the signal input to the second mixer 7b leads 90 degrees to a phase of the signal input to the first mixer 7a.

In addition, the LO signal input from the LO input terminal 2 is distributed by the 90-degree LO distributor 5 with a phase difference of 90 degrees and is input to the two mixers 7a and 7b. In this case, it is supposed that a phase of the LO signal input to the second mixer 7b is delayed by 90 degrees to a phase of the LO signal input to the first mixer 7a.

In the first mixer 7a, the input LO signal and IF signal are mixed so that a mixed wave of A times a frequency of the LO signal frequency and B times a frequency of the IF signal frequency is output. Here, each phase of the LO signal and the IF signal input to the first mixer 7a is regarded as a reference (0 degree). Then, a phase of the output signal component (A×LO+B×IF) is 0 degree.

Similarly, also in the second mixer 7b, the LO signal and the IF signal are mixed so that a mixed wave of A times a frequency of the LO signal frequency and B times a frequency of the IF signal frequency is output. A phase of the IF signal input to the second mixer 7b is +90 degrees with respect to the phase of the IF signal input to the first mixer 7a, and a phase of the LO signal is −90 degrees. Therefore, a phase of the output signal component (A×LO+B×IF) is as follows.

A×(−90)+B×90 degrees (1)

The signals output from the two mixers 7a and 7b are synthesized in the 90-degree RF synthesis distributor 6 and output from an RF terminal 3. Here, when the signal from the second mixer 7b is delayed by a phase of 90 degrees and is synthesized with the signal from the first mixer 7a, a phase φ of the synthesized signal is as follows.

$$\begin{matrix}ϕ = - 90 + A \times ( - 90 ) + B \times 90 \\ = 90 \times ( B - A - 1 )\end{matrix} \qquad ( 2 )$$

When this phase φ becomes “0 degree” or “multiple of 360 degrees”, the in-phase synthesis is performed so that a maximum power may be extracted. If it is a “180 degrees+multiple of 360 degrees”, it is suppressed by the opposite phase synthesis.

(The Case of Fourth-Order Harmonic Mixer)

It is understood that the RF signal components of the desired wave have A=4, B=1, and φ=−360 degrees, and are synthesized in phase, while image frequencies have A=4, B=−1, and φ=−540 degrees, and are synthesized in opposite phase, which operates as an image rejection mixer.

Further, as an example of the harmonic components that are output at the vicinity of the desired wave, components of relatively low order and relatively high output level such as 2LO+IF (=−180 degrees), 2LO−3IF (=−540 degrees), 3LO+2IF (=−180 degrees), 3LO−2IF (=−540 degrees), 4LO+3IF (=−180 degrees), 5LO (=−540 degrees), 5LO−4IF (−900 degrees), and 6LO−3IF (=−900 degrees) are also synthesized in opposite phase and may be suppressed in theory.

In this way, the structure has an effect of suppressing in theory undesired waves generated by a combination of the LO signal frequency and the IF signal frequency to be φ=180+360N (N is an integer) illustrated in the equation (2) like 2LO+IF, 3LO+2IF, 5LO, or the like, in which image rejection function remains. The mixer uses a fourth order of the LO signal, and hence even if the LO signal has a difference of 90 degrees, a phase difference of the 4L0 signal component in the two mixers becomes 360 degrees=0 degree. As to the desired wave and the image wave, the same operation as the conventional operation may be performed, and it may be said that the structure is unique to the fourth-order harmonic mixer.

As a concrete example, a list of spurious is shown in Table 1.

TABLE 1

| | LO | IF | | | Suppressed by | Suppressed by |
|---|---|---|---|---|---|---|
| | order | order | RF | φ | IRM/APDP | this structure |
| a | 4 | −4 | 44 | −810 | ∘ | |
| b | 3 | 3 | 45 | −90 | ∘ | |
| c | 4 | −3 | 46 | −720 | | |
| d | 3 | 4 | 47 | 0 | | |
| e | 4 | −2 | 48 | −630 | ∘ | |
| f | 3 | 5 | 49 | 90 | ∘ | |
| g | 4 | −1 | 50 | −540 | ∘ Image wave | ∘ |
| h | 4 | 0 | 52 | −450 | ∘ | |
| i | 4 | 1 | 54 | −360 | Desired wave | |
| j | 5 | −5 | 55 | −990 | ∘ | |
| k | 4 | 2 | 56 | −270 | ∘ | |
| l | 5 | −4 | 57 | −900 | | ∘ |
| m | 4 | 3 | 58 | −180 | | ∘ |
| n | 5 | −3 | 59 | −810 | ∘ | |
| o | 4 | 4 | 60 | −90 | ∘ | |
| p | 5 | −2 | 61 | −720 | | |
| q | 4 | 5 | 62 | 0 | | |
| r | 5 | −1 | 63 | −630 | ∘ | |

LO = 13 GHz, IF = 2 GHz

It is supposed that LO signal frequency is 13 GHz, IF signal frequency is 2 GHz, LO signal order is four. The fourth-order harmonic mixer is considered to have a desired wave of 54 GHz that is an output frequency when the IF signal order is one. Components of mixed waves that exist at the vicinity of the desired wave (±10 GHz) are shown. Here, the upper limit of the order of the LO signal and the order of the IF signal is five. There are 18 frequency components including the desired wave.

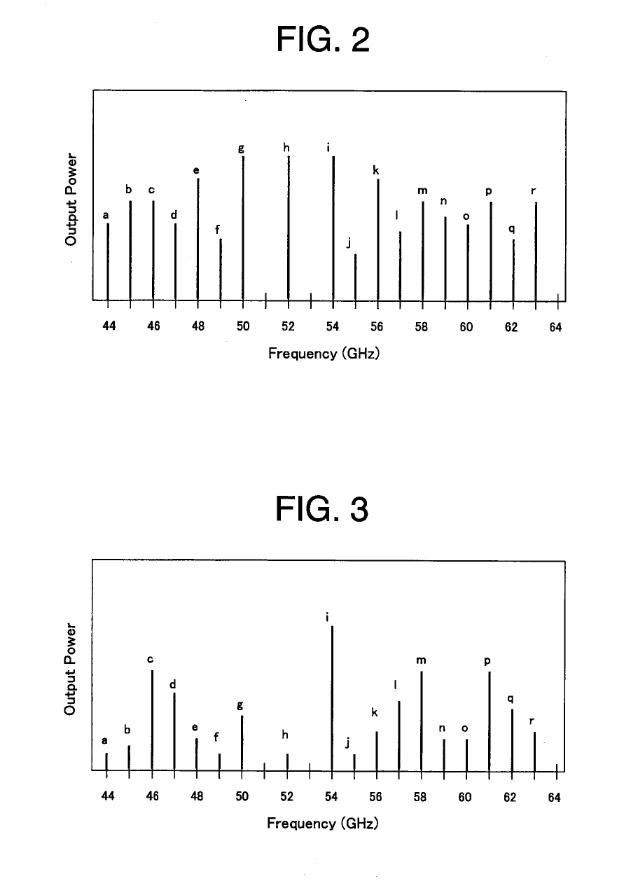

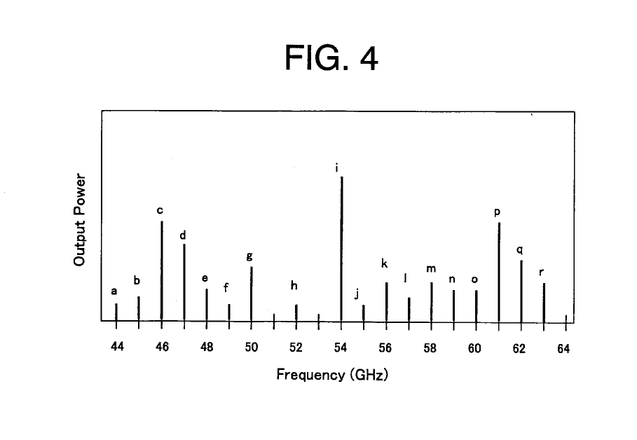

FIG. 2 illustrates spectrum characteristics of the conventional mixer, in which the horizontal axis represents frequency (GHz) and the vertical axis represents output power. FIG. 3 illustrates output spectrum in the conventional image rejection mixer having a structure using an even harmonic mixer with an APDP. Further, FIG. 4 illustrates output spectrum in the case of the structure described as Embodiment 1 in which the APDP is used for the first and the second fourth-order harmonic mixers 7a and 7b, and further the 90-degree LO distributor 5 for distributing an output having a phase difference of 90 degrees is used for an LO frequency distributor.

As illustrated in FIG. 3, the APDP suppresses a wave having an even sum of the order of the LO signal and the order of the IF signal. In addition, according to this structure, as illustrated in FIG. 4, if the equation (2) is “180 degrees+multiple of 360 degrees”, it is suppressed by the opposite phase synthesis. Therefore, a spurious component at the very vicinity of the desired wave is suppressed. There is an effect of allowing specifications required to the filter after the mixer to be relieved.

Specifically, in the case of FIG. 2, there are a lot of spurious of high output power at the vicinity of desired 54 GHz, and the even harmonic mixer using the APDP suppresses a wave having an even sum of the order of the LO signal and the order of the IF signal as illustrated in FIG. 3. However, the components I and m that are apart from the desired wave (component i in FIG. 3) by 3 GHz or 4 GHz are not suppressed. Therefore, a steep filter for suppressing the components I and m is necessary. If this embodiment is used, as illustrated in FIG. 4, the components are suppressed, and hence there is an effect of allowing the specification required to the steep filter to be relieved.

Although the case of the transmission system is described above, the case of the reception system also has the same effect.

### Embodiment 2

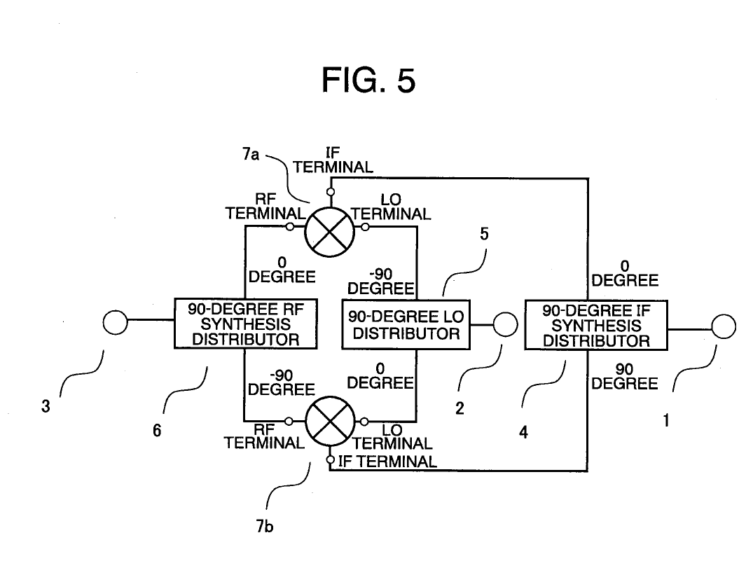

FIG. 5 is a block diagram illustrating a structure of an image rejection mixer according to Embodiment 2 of the present invention. In FIG. 5, the same portion as that in FIG. 1 is denoted by the same reference symbol so that overlapping description thereof is omitted. Embodiment 2 illustrated in FIG. 5 is different from Embodiment 1 illustrated in FIG. 1 in that the 90-degree LO distributor 5 in Embodiment 1 outputs from the third terminal a signal having a phase delay of 90 degrees with respect to the phase output from the second terminal, while the 90-degree LO distributor 5 in Embodiment 2 outputs the signal having the phase delay of 90 degrees with respect to the phase output from the third terminal from the second terminal.

An operation of the image rejection mixer according to Embodiment 2 is similar to that in Embodiment 1. When the 90-degree RF synthesis distributor 6 synthesizes the signals from the two mixers 7a and 7b, the phase φ of the synthesized wave becomes as follows.

$$\begin{matrix}ϕ = - 90 + A \times ( 90 ) + B \times 90 \\ = 90 \times ( A + B - 1 )\end{matrix} \qquad ( 3 )$$

When this phase φ becomes “0 degree” or “multiple of 360 degrees”, the in-phase synthesis is performed so that a maximum power may be extracted. If it is a “180 degrees+multiple of 360 degrees”, it is suppressed by the opposite phase synthesis.

(The Case of Fourth-Order Harmonic Mixer)

It is understood that the RF signal components of the desired wave have A=4, B=1, and φ=360 degrees, and are synthesized in phase, while image frequencies have A=4, B=−1, and φ=180 degrees, and are synthesized in opposite phase, which operates as an image rejection mixer.

Further, as an example of the harmonic components that are output at the vicinity of the desired wave, components of relatively low order and relatively high output level such as 2LO+IF (=180 degrees), 2LO−3IF (=180 degrees), 3LO+4IF (=540 degrees), 3LO−4IF (=−180 degrees), 4LO+3IF (=540 degrees), and 5LO+2IF (540 degrees) are also synthesized in opposite phase and may be suppressed in theory.

In addition, the effect is also the same as that in Embodiment 1. A spurious component appearing at the vicinity of the desired wave depends on a selection method of the LO signal frequency and the IF signal frequency. Therefore, if Embodiment 1 or Embodiment 2 is selected in accordance with the spurious component to be suppressed, higher effect may be obtained.

Although the case of the transmission system is described above, the case of the reception system also has the same effect.

### Embodiment 3

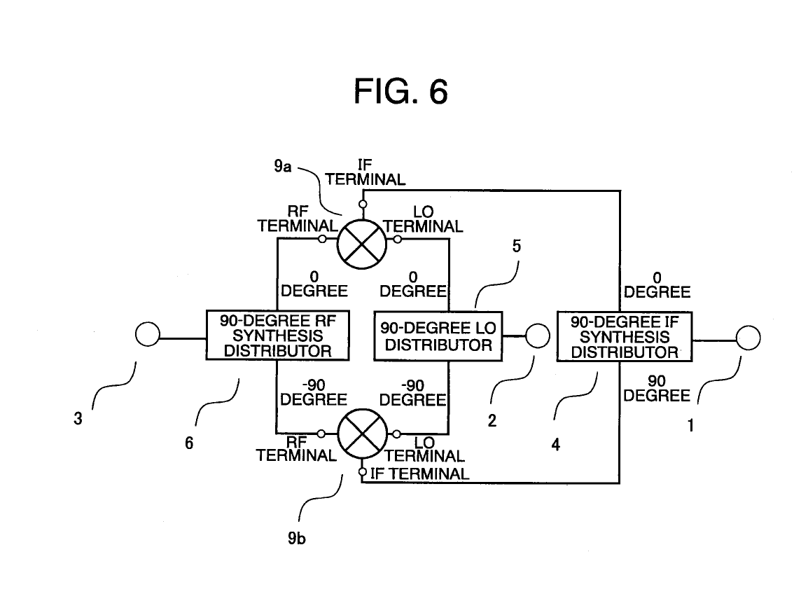

FIG. 6 is a block diagram illustrating a structure of an image rejection mixer according to Embodiment 3 of the present invention. In FIG. 6, the same portion as that in FIG. 1 is denoted by the same reference symbol so that overlapping description thereof is omitted. Embodiment 3 illustrated in FIG. 6 is different from Embodiment 1 illustrated in FIG. 1 in that the first and the second fourth-order harmonic mixers are 4n-th order harmonic mixers 9a and 9b that output the RF as a mixed wave of the 4n-th (n is an integer except 0) order component of the input LO signal frequency and the IF first order component.

An operation of the image rejection mixer according to Embodiment 3 is similar to that illustrated in Embodiments 1 and 2. When described in accordance with Embodiment 1, the phase φ of the wave synthesized by the 90-degree RF synthesis distributor 6 becomes as follows.

$$\begin{matrix}ϕ = - 90 + A \times ( - 90 ) + B \times 90 \\ = 90 \times ( B - A - 1 )\end{matrix} \qquad ( 4 )$$

When this phase φ becomes “0 degree” or “multiple of 360 degrees”, the in-phase synthesis is performed so that a maximum power may be extracted. If it is a “180 degrees+multiple of 360 degrees”, it is suppressed by the opposite phase synthesis.

In this way, according to this structure, as to multiple of the fourth order, there is an effect of allowing image rejection function to remain while suppressing in theory undesired waves generated by a combination of the LO frequency and the IF frequency to be φ=180+360n illustrated in the equation (4). The mixer uses the 4n-th order of the LO, and hence even if the LO has a difference of 90 degrees, a phase difference of the 4n-th order LO component in the two mixers becomes 360×n=0 degree. Therefore, the desired wave and the image wave may operate similarly to those in the conventional example.

Although the case of the transmission system is described above, the case of the reception system also has the same effect.

### Embodiment 4

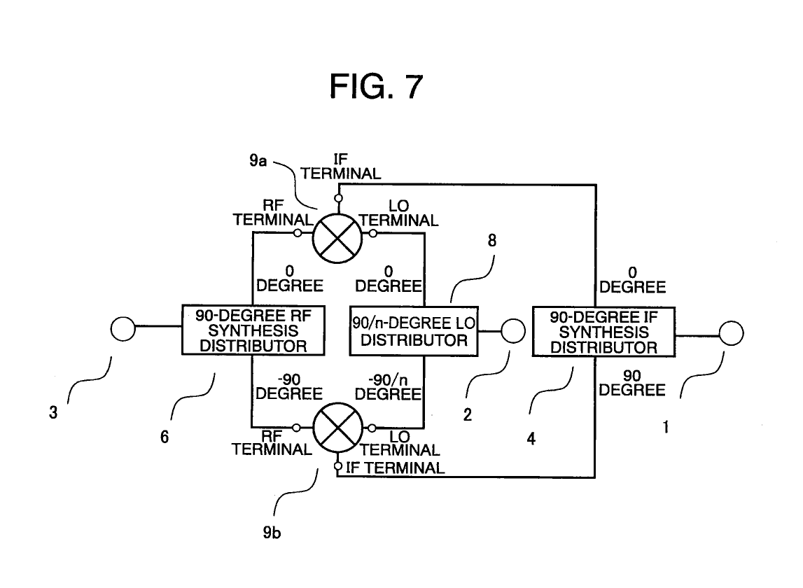

FIG. 7 is a block diagram illustrating a structure of an image rejection mixer according to Embodiment 4 of the present invention. In FIG. 7, the same portion as that in FIG. 6 is denoted by the same reference symbol so that overlapping description thereof is omitted. Embodiment 4 illustrated in FIG. 7 is different from Embodiment 3 illustrated in FIG. 6 in that a 90/n (n is an integer except 0) degree distributor 8 is used as the 90-degree LO distributor.

An operation of the image rejection mixer according to Embodiment 4 is similar to that illustrated in Embodiments 1 to 3. When described in accordance with Embodiment 1, the phase φ of the wave synthesized by the 90-degree RF synthesis distributor 6 becomes as follows.

$$\begin{matrix}ϕ = - 90 + A \times ( - 90 n ) + B \times 90 \\ = 90 \times ( B - A / n - 1 )\end{matrix} \qquad ( 5 )$$

When this phase φ becomes “0 degree” or “multiple of 360 degrees”, the in-phase synthesis is performed so that a maximum power may be extracted. If it is a “180 degrees+multiple of 360 degrees”, it is suppressed by the opposite phase synthesis.

Although the case of the transmission system is described above, the case of the reception system also has the same effect.

### Embodiment 5

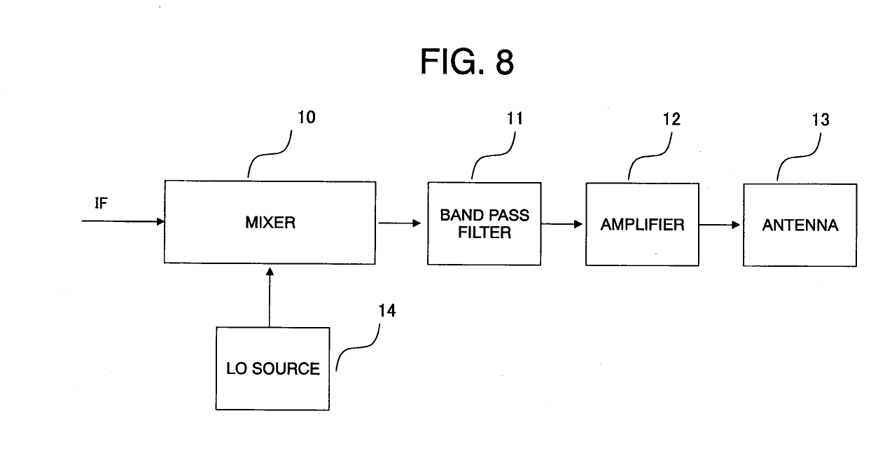

FIG. 8 is a block diagram illustrating a structure of a wireless communication device according to Embodiment 5 of the present invention. The wireless communication device illustrated in FIG. 8 is an example of the case in which an image rejection mixer 10 described above in Embodiments 1 to 4 is used for constituting a transmission unit of a communication device or a radar device. After the mixer 10, a band pass filter 11 suppresses a spurious component output by the mixer 10, an amplifier 12 amplifies the signal to a desired power, and an antenna 13 radiates the signal. Note that reference numeral 14 denotes an LO source. In this case, if the band pass filter 11 is steep, loss in the band increases, and hence a gain required to the amplifier 12 is increased according to the loss. The specification required to the band pass filter 11 may be relieved, and the loss is decreased by using the mixer described above in Embodiments 1 to 4, and hence the specification required to the amplifier 12 is also relieved as a merit.

1. An image rejection mixer, comprising:
first and second fourth-order harmonic mixers, each including an LO terminal, an IF terminal, and an RF terminal, and outputs, as a desired wave, an RF as a mixed wave of a fourth order component of an input LO signal frequency and a first order component of an IF, or the IF as a mixed wave of an even order component of the input LO signal frequency and a first order component of the RF;
a 90-degree IF synthesis distributor which distributes and outputs an input signal at a first terminal from second and third terminals with a phase difference of 90 degrees, or synthesizes an input signal at a second terminal and an input signal at a third tell final after delaying a phase of the input signal at the second terminal by 90 degrees and outputs the synthesized signal from the first terminal;
a 90-degree LO distributor which distributes and outputs an input signal at a first terminal from second and third terminals with a phase difference of 90 degrees; and
a 90-degree RF synthesis distributor which distributes and outputs an input signal at a first terminal from second and third terminals with a phase difference of 90 degrees and outputs from a third terminal a signal having a phase delay of 90 degrees with respect to a phase output from the second terminal, or synthesizes an input signal at a second terminal with an input signal at a third terminal after leading a phase of the input signal at the second terminal by 90 degrees and outputs the synthesized signal from the first terminal, wherein:
the second terminal of the 90-degree IF synthesis distributor is connected to the IF terminal of the first fourth-order harmonic mixer;
the third terminal of the 90-degree IF synthesis distributor is connected to the IF terminal of the second fourth-order harmonic mixer;
the second terminal of the 90-degree LO distributor is connected to the LO terminal of the first fourth-order harmonic mixer;
the third terminal of the 90-degree LO distributor is connected to the LO terminal of the second fourth-order harmonic mixer;
the second terminal of the 90-degree RF synthesis distributor is connected to the RF terminal of the first fourth-order harmonic mixer; and
the third terminal of the 90-degree RF synthesis distributor is connected to the RF terminal of the second fourth-order harmonic mixer.

2. The image rejection mixer according to claim 1, wherein the 90-degree LO distributor outputs from the third terminal a signal having a phase delay of 90 degrees with respect to a phase output from the second terminal.

3. The image rejection mixer according to claim 1, wherein the 90-degree LO distributor outputs from the second terminal a signal having a phase delay of 90 degrees with respect to a phase output from the third terminal.

4. The image rejection mixer according to claim 1, wherein each of the first and the second fourth-order harmonic mixers is a 4n-th order harmonic mixer which outputs an RF as a mixed wave of a 4n-th (n is an integer except 0) component of the input LO signal frequency and the first order component of the IF.

5. The image rejection mixer according to claim 4, wherein the 90-degree LO distributor is a 90/n (n is an integer except 0) degree distributor.

6. A wireless communication device comprising the image rejection mixer according to claim 1.
